(19) United States
(12) Patent Application Publication
(10) Pub. No.: US 2025/0111436 A1
(43) Pub. Date: Apr. 3, 2025

(54) DIGITAL ASSET MANAGEMENT SYSTEM AND MANAGEMENT METHOD

(71) Applicants: CHI-CHING CHEN, NEW TAIPEI CITY (TW); NET ALLIANCE CO., LTD., NEW TAIPEI CITY (TW)

(72) Inventor: CHI-CHING CHEN, NEW TAIPEI CITY (TW)

(21) Appl. No.: 18/390,429

(22) Filed: Dec. 20, 2023

(30) Foreign Application Priority Data
Sep. 28, 2023 (TW) 112137793

(51) Int. Cl. G06Q 40/06; G06Q 20/10; G06Q 20/36; G06Q 20/38; G06Q 40/04

(52) U.S. Cl. CPC G06Q 40/06; G06Q 20/10; G06Q 20/3678; G06Q 20/3829; G06Q 20/389; G06Q 40/04

(57) ABSTRACT

This invention provides a digital asset management system and management method, and includes a financial unit and a digital asset regulatory unit. Users can apply for a regulatory account from the digital asset regulatory unit to establish a connection between a financial account of the financial institution, the regulatory account of the digital asset regulatory unit, and an exchange account of a digital asset exchange. A digital asset data purchased by users through the digital asset exchange will not remain in the exchange account for a long time, but will be immediately transferred and stored in the regulatory account of the digital asset regulatory unit through the financial unit. The digital asset regulatory unit includes a transaction ledger to store a public key and a private key of the digital asset data.

### CROSS-REFERENCE TO RELATED APPLICATIONS

This non-provisional application claims priority claim under 35 U.S.C. § 119(a) on Taiwan invention application No. 112137793 filed on Sep. 28, 2023, the entire contents of which are incorporated herein by reference.

### TECHNICAL FIELD

This invention relates to a digital asset management system and management method, which allows digital assets to be stored in a digital asset regulatory unit rather than being stored in a digital asset exchange for a long time, thereby enhancing the security of digital asset transactions.

### BACKGROUND

Please refer to FIG. 1, which is an illustrative diagram of a conventional digital asset trading system. The digital asset trading system 10 mainly includes a user 11, a financial unit 13 and a digital asset exchange 15. The user 11 can apply for a financial account 131 from the financial unit 13, such as a bank, and deposit a deposit amount 133 in the financial account 131. The user 11 can apply for an exchange account 151 from the digital asset exchange 15, such as Bitfinex, Binance, Coinbase, Kraken, Bitstamp or Gemini. When the user 11 wants to purchase a digital asset, such as Bitcoin, Ethereum, Dogecoin, or non-fungible tokens (NFTs), etc., he can transfer the deposit amount 133 in the financial account 131 of the financial unit 13 to the exchange account 151 in the digital asset exchange 15, which becomes a transaction amount 153. Thereafter, the digital asset exchange 15 will perform asset conversion and record relevant data in the digital asset exchange 15, such as registering or storing the digital asset value 155, such as N bitcoins, purchased by the user 11 and the remaining transaction amount 153 in exchange account 151. Conversely, if the user 11 wants to sell the digital asset value 155, he can notify the digital asset exchange 15 to sell the digital asset value 155 in the exchange account 151 in exchange for the transaction amount 153. The digital asset exchange 15 will perform asset conversion and record relevant data. In other words, the digital asset exchange 15 can assist the user 11 in converting and managing the transaction amount 153 and the digital asset value 155.

Since the digital asset exchange 15 stores a large amount of transaction amount 153 and digital asset value 155, it is an easy target for cybercriminals or theft by employees of the digital asset exchange 15. As a result, the digital asset value 155 or transaction amount 153 stored in the exchange account 151 of the user 11 may be illegally misappropriated. In addition, the digital asset exchange 15 may suddenly go bankrupt due to poor management, causing the user 11 to be unable to withdraw the transaction amount 153 or digital asset value 155 in the exchange account 151, resulting in huge losses for the user 11.

Therefore, the user 11 has the option to download the digital asset value 155 and transaction amount 153 from the exchange account 151 to a cryptocurrency wallet 17. Alternatively, the user 11 may transfer the transaction amount 153 to the financial account 131 of financial unit 13, to become the deposit amount 133. At this time, the digital asset exchange 15 may convert the digital asset value 155 into a digital asset data 173 or conduct the trading of the digital asset value 155 through a blockchain 19 to obtain the digital asset data 173. Subsequently, the digital asset data 173 can be extracted and downloaded to the cryptocurrency wallet 17 of the user 11. The digital asset data 173 comprises at least one public key 175 and at least one private key 177. When user 11 extracts and downloads the digital asset data 173 to the cryptocurrency wallet 17, the digital asset exchange 15 may erase the digital asset value 155, the transaction amount 153, and/or the digital asset data 173.

When the user 11 applies for the financial account 131 or the exchange account 151, he needs to go through identity verification by the financial unit 13 or the digital asset exchange 15, such as anti-money laundering (AML) and/or know-your-customer (KYC) procedures, and obtain the password for the financial account 131 or the exchange account 151.

The cryptocurrency wallet 17 offers higher security to avoid attacks by cybercriminals or unauthorized sales on digital asset exchange 15. However, when the cryptocurrency wallet 17 is damaged or when the user 11 forgets the private key 177, the user 11 is unable to access or transact with the digital asset data 173 stored within the cryptocurrency wallet 17.

### SUMMARY

This invention provide a digital asset management system and management method. This invention mainly stores a digital asset data in a regulatory account of a digital asset regulatory unit, which not only avoids hacker attacks to improve the security of the digital asset data, but also avoids improper management of a digital asset exchange.

An objective of this invention is to provide a digital asset management system and management method. The invention mainly stores a private key of a digital asset data in the regulatory account or a transaction ledger of the digital asset regulatory unit, which can avoid the cryptocurrency wallet being lost or forgetting the private key, resulting in the digital asset data being unable to be traded.

Another objective of this invention is to provide a digital asset management system and management method. Users can apply for a digital asset dual-reading card from a financial unit, wherein the digital asset dual-reading card serves not only for shopping but also facilitates the buying and selling of digital asset data, thereby enhancing the convenience of digital asset transactions.

To achieve the abovementioned object(s), the present disclosure provides a digital asset management system, comprising: a financial unit comprising a financial account, wherein the financial account is connected to a cryptocurrency wallet or located in an exchange account of a digital asset exchange; and a digital asset regulatory unit connected to the financial unit, and comprising a regulatory account that corresponds to the financial account, wherein the regulatory account stores at least one digital asset data that comprises a public key and a private key.

The present disclosure also provides a digital asset management method, comprising: applying for a regulatory account by a user from a digital asset regulatory unit, or applying for the regulatory account by the user from the digital asset regulatory unit through a financial unit, wherein the regulatory account is located within the digital asset regulatory unit; establishing a connection between the regulatory account and a financial account; establishing a connection between the financial account and an exchange account or a cryptocurrency wallet; and storing at least one digital asset data in the regulatory account, wherein the digital asset data is transmitted from the exchange account or the cryptocurrency wallet, wherein the digital asset data includes a public key and a private key.

### BRIEF DESCRIPTION OF THE DRAWINGS

The structure as well as preferred modes of use, further objects, and advantages of this present disclosure will be best understood by referring to the following detailed description of some illustrative embodiments in conjunction with the accompanying drawings, in which:

FIG. 1 is an illustrative diagram of a conventional digital asset trading system.

FIG. 2 is an illustrative diagram of the digital asset management system according to an embodiment of the invention.

FIG. 3 is a flow chart of the digital asset management method according to an embodiment of the invention.

FIG. 4 is an illustrative diagram of the digital asset management system according to another embodiment of the invention.

FIG. 5 is a flow chart of the digital asset management method according to another embodiment of the invention.

FIG. 6 is a flow chart of the digital asset management method according to another embodiment of the invention.

FIG. 7 is a flow chart of the digital asset management method according to another embodiment of the invention.

FIG. 8 is a flow chart of the digital asset management method according to another embodiment of the invention.

FIG. 9 is an illustrative diagram of the digital asset management system according to another embodiment of the invention.

FIG. 10 is an illustrative diagram of the digital asset management system according to another embodiment of the invention.

### DETAILED DESCRIPTION OF THE PREFERRED EMBODIMENTS

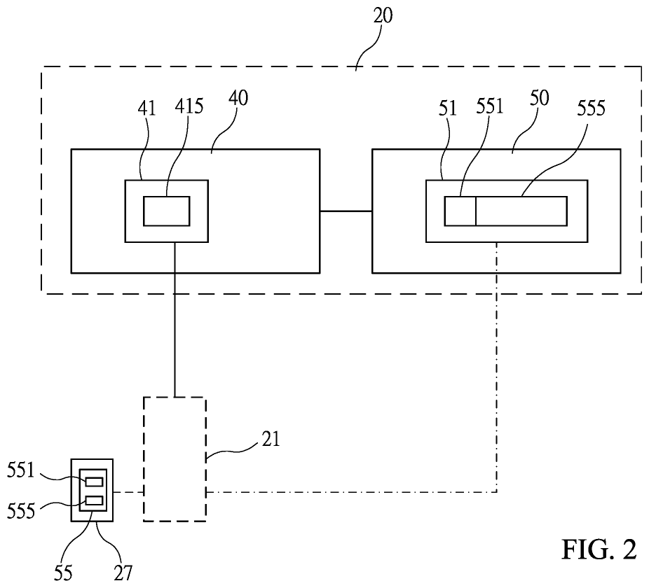

Please refer to FIG. 2, which is an illustrative diagram of a digital asset management system according to an embodiment of the invention. The digital asset management system 20 comprises a financial unit 40 and a digital asset regulatory unit 50. The financial unit 40 has at least one financial account 41, which stores a deposit amount 415. The digital asset regulatory unit 50 has a corresponding regulatory account 51 for each financial account 41, and the regulatory account 51 stores at least one digital asset data 55. Each digital asset data 55 includes at least one public key 551 and a corresponding private key 555.

In one embodiment of the invention, a user 21 can directly connect to the digital asset regulatory unit 50 or connect to the digital asset regulatory unit 50 through the financial unit 40 to apply for their own regulatory account 51 from the digital asset regulatory unit 50. The user 21 can upload at least one digital asset data 55 from a cryptocurrency wallet 27 to the corresponding regulatory account 51. Further, the digital asset data 55 in the regulatory account 51 can be downloaded to the cryptocurrency wallet 27.

The digital asset data 55 stored in the cryptocurrency wallet 27 may be obtained when conducting digital asset transactions from the digital asset exchange 30 or a blockchain 29. The digital asset data 55 comprises a public key 551 and a corresponding private key 555.

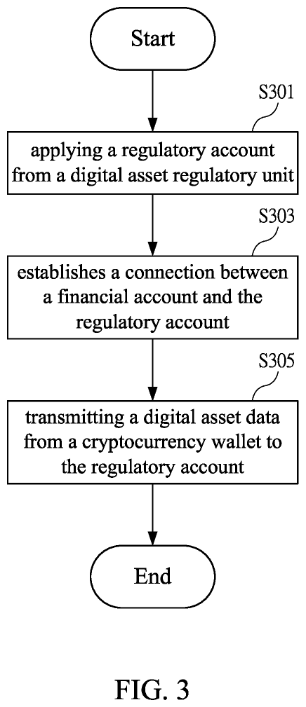

Please refer to FIG. 3, which is a flowchart of a digital asset management method according to an embodiment of the invention. Referring to FIG. 2, the digital asset management method of the invention includes the following steps:

In step S301, a user 21 may directly connect to the digital asset regulatory unit 50 or connect to the digital asset regulatory unit 50 through the financial unit 40 for applying a regulatory account 51 owned by the user 21 from the digital asset regulatory unit 50.

In step S303, the user 21 applies for a financial account 41 from the financial unit 40 or specifies the financial account 41 of the financial unit 40, and establishes a connection and corresponding relationship between the financial account 41 and the regulatory account 51.

In step S305, the user 21 uploads the digital asset data 55 from the cryptocurrency wallet 27 to the regulatory account 51 directly, or uploads the digital asset data 55 to the regulatory account 51 through the financial unit 40, and stores the digital asset data 55 is stored in the regulatory account 51.

In other words, the regulatory account 51 of the digital asset regulatory unit 50 is like another type of cryptocurrency wallet, but the security of the regulatory account 51 is much higher than that of a general cryptocurrency wallet 27. The digital asset regulatory unit 50 may be established and managed by a government agency, a financial unit 40, or a third-party impartial institution, such as the Taiwan Depository & Clearing Corporation, which is used to concentrate the custody of stocks or securities. The internal management and prevention of hacker intrusion capabilities of the digital asset regulatory unit 50 are higher than those of general digital asset exchanges, and there is no risk of sudden bankruptcy. It will not be damaged or lost like a cryptocurrency wallet 27. Therefore, the security of digital asset data 55 stored in the regulatory account 51 is higher than that of a cryptocurrency wallet 27 or a digital asset exchange 30.

In another embodiment of the invention, the digital asset data 55 in the regulatory account 51 can be downloaded and stored in the cryptocurrency wallet 27 of the user 21. After the digital asset data 55 is transmitted from the regulatory account 51 to the cryptocurrency wallet 27, the regulatory account 51 will record the download data.

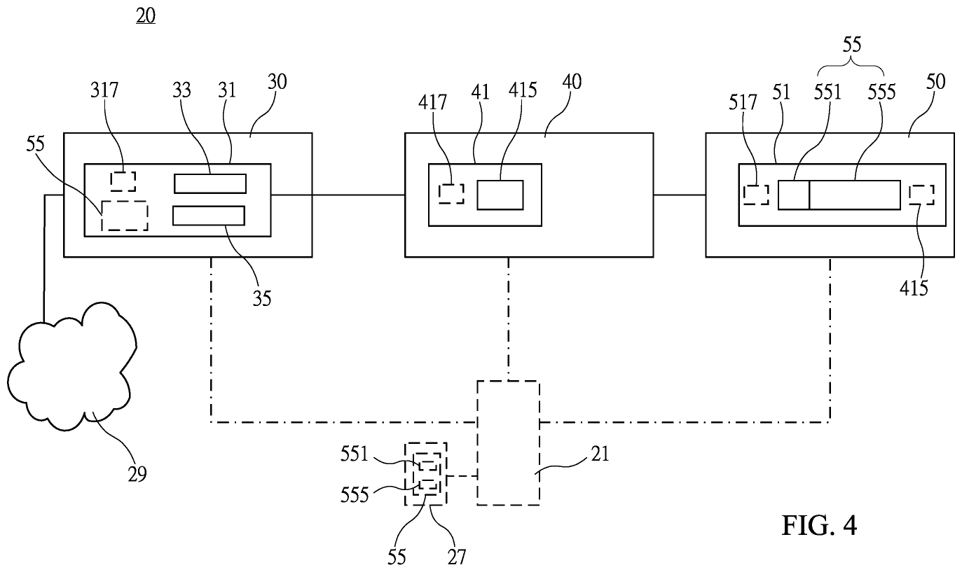

Please refer to FIG. 4, which is an illustrative diagram of the digital asset management system according to another embodiment of the invention. A user 21 may apply for an exchange account 31 through the financial unit 40 or directly with a digital asset exchange 30, such as Bitfinex, Binance, Coinbase, Kraken, Bitstamp, or Gemini. The financial account 41 of the user 21 can be connected online to the exchange account 31. At least one digital asset data 55 owned by the user 21 can be transmitted between the exchange account 31 of the digital asset exchange 30 and the regulatory account 51 of the digital asset regulatory unit 50 through the financial unit 40. The digital asset exchange 30 can connect to a blockchain 29 and trade the digital asset value 35, such as digital assets, on the blockchain 29.

In one embodiment of the invention, the user 21 must undergo identity verification procedures, such as anti-money laundering (AML) and/or know-your-customer (KYC), when applying for financial accounts 41, regulatory accounts 51, and/or exchange accounts 31 from the financial unit 40, the digital asset regulatory unit 50, and/or the digital asset exchange 30. The user 21 will be given passwords for the financial account 41, the regulatory account 51, or the exchange account 31, such as a financial password 417, a regulatory password 517, or an exchange password 317. The financial password 417, the regulatory password 517, and the exchange password 317 can be changed by user 21 at will. When the user 21 forgets their passwords, they can apply to update their passwords from the financial unit 40, the digital asset regulatory unit 50 or the digital asset exchange 30. The update steps may be the same as the method for forgetting bank passwords.

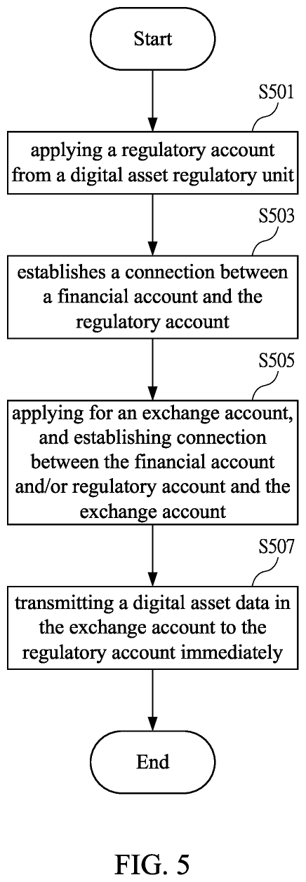

Please refer to FIG. 5, which is a flowchart of the digital asset management method according to another embodiment of the invention. In this case, step S501 is the same as the previous step S301, step S503 is the same as step S303. The invention further includes the following steps:

In step 505, the user 21 directly or through the financial unit 40 applies for an exchange account 31 from the digital asset exchange 30. For example, the digital asset exchange 30 includes Bitfinex, Binance, Coinbase, Kraken, Bitstamp, or Gemini exchanges. The financial unit 40 and/or the digital asset exchange 30 establish an online connection and corresponding relationship between the financial account 41 and/or regulatory account 51 and the exchange account 31 of the user 21. If the user 21 has an exchange account 31 in the digital asset exchange 30, the financial unit 40 and/or the digital asset exchange 30 can negotiate and establish a connection and corresponding relationship between the financial account 41 and the exchange account 31 through user's notification and authorization.

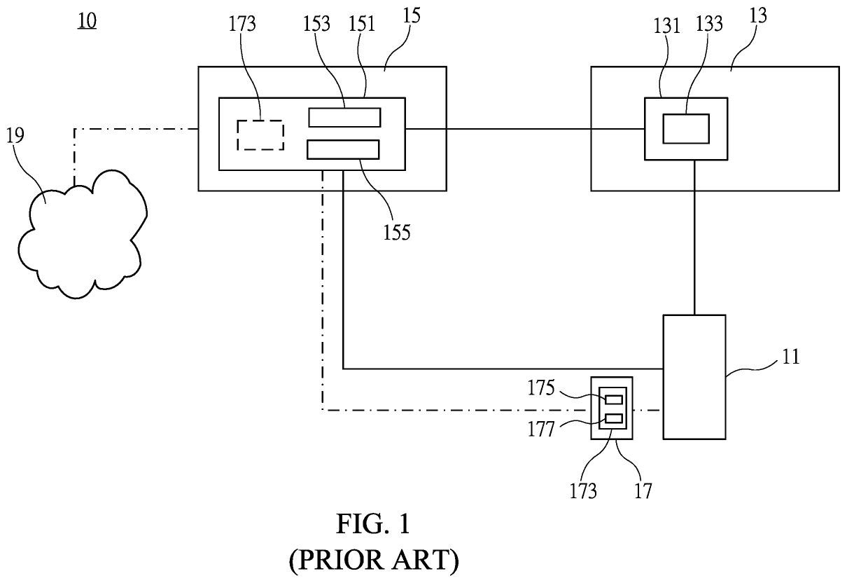

In step S507, if the exchange account 31 of the user 21 has stored at least one digital asset value 35, the digital asset value 35 can be converted into digital asset data 55 and immediately stored in the regulatory account 51 of the digital asset regulatory unit 50 through the financial unit 40 or directly. In other words, when the user 21 instructs the digital asset exchange 30 to directly submit the digital asset value 35 from the exchange account 31, the digital asset exchange 30 will convert the same value of the digital asset data 55 from its internal assets or from an actual transaction on a blockchain 29, and upload it to the agreed regulatory account 51. The digital asset data 55 comprises at least a public key 551 and the corresponding private key 555. The process of converting the digital asset value 35 into the digital asset data 55 by the digital asset exchange 30 is similar to the method described in FIG. 1.

The digital asset value 35 is not stored in the digital asset exchange 30 of a private company, and is immediately stored in the regulatory account 51 of the digital asset regulatory unit 50. The digital asset regulatory unit 50 is established by a government agency, a financial unit, or a fair third-party agency, such as the Taiwan Depository & Clearing Corporation in Taiwan. In addition, the digital asset regulatory unit 50 may be a semi-closed institution that can only connect and transmit data with the financial unit 40, so that the digital asset data 55 in the regulatory account 51 can only be transmitted to or transmitted from the digital asset regulatory unit 50 through the financial unit 40 or over-the-counter, and cannot be connected from other external networks. Therefore, the invention can not only significantly reduce the risk of hacker attacks and theft by employees of digital asset exchanges 30, but also solve the risk of sudden bankruptcy of the digital asset exchange 30.

In one embodiment of the invention, when the exchange account 31 of the user 21 has the digital asset value 35 and/or the digital asset data 55 due to trading, the digital asset exchange 30 will actively and immediately transmit them to the regulatory account 51 of the digital asset regulatory unit 50 through the financial unit 40, or directly upload them to the regulatory account 51 of the digital asset regulatory unit 50. Conversely, if the digital asset data 55 in the regulatory account 51 is to be transferred to the exchange account 31, the user 21 must activate the portal website or application (APP) of the digital asset regulatory unit 50 and enter the regulatory password 517. After that, the user 21 can transmit one of the digital asset data 55 to the exchange account 31 according to the user's operation, in order to sell the digital asset 33 in the future.

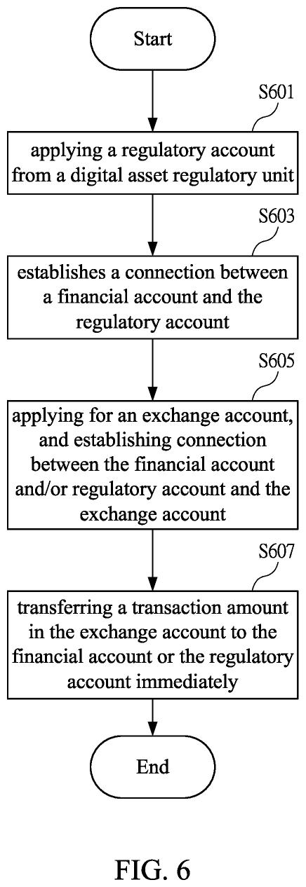

Please refer to FIG. 6, which is a flow chart of the digital asset management method according to another embodiment of the invention. Step S601 is the same as the step S501, step S603 is the same as step S503, and step S605 is the same as step S505. The invention further includes the following steps:

In step S607, if a transaction amount 33 has been stored in the exchange account 31 owned by the user 21, the transaction amount 33 will be immediately transferred to the financial account 41 of the financial unit 40 or the regulatory account 51 of the digital asset regulatory unit 50, and become a deposit amount 415.

In one embodiment of the invention, the user 21 can transfer the deposit amount 415 in the financial account 41 to the exchange account 31, and become a transaction amount 33, to purchase digital asset data 55. The remaining transaction amount 33 after purchasing digital asset data 55, or the transaction amount 33 obtained after selling digital asset data 55, or the transaction amount 33 previously stored in the exchange account 31, will be actively and immediately transferred to the financial account 41 or regulatory account 51 of the user 21, and become a deposit amount 415.

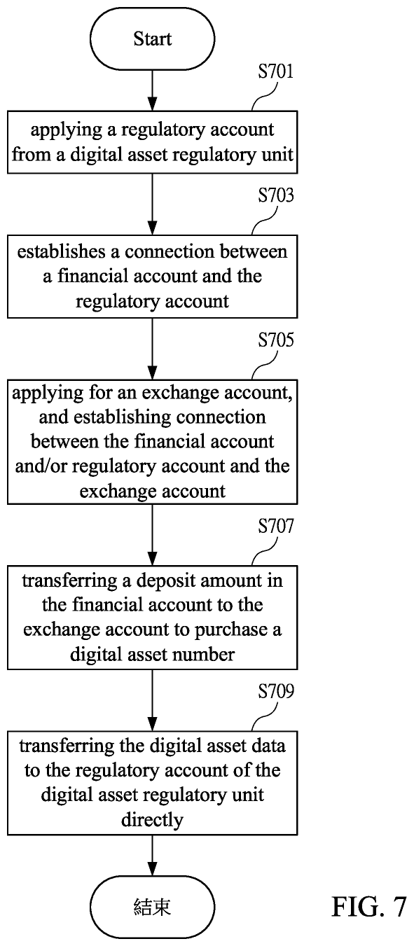

Please refer to FIG. 7, which is a flow chart of the digital asset management method according to another embodiment of the invention. Step S701 is the same as the step S601, step S703 is the same as step S603, and step S705 is the same as step S605. The invention further includes the following steps:

In step S707, when the user 21 wants to purchase digital assets, the user 21 notifies the financial unit 40 to transfer the deposit amount 415 in the financial account 41 to the exchange account 31 of the digital asset exchange 30, and become a transaction amount 33. The digital asset exchange 30 may purchase the digital asset value 35 through the blockchain 29 using the transaction amount 33, or convert transaction amount 33 to the digital asset value 35 from internal database of the digital asset exchange 30. The digital asset value 35 may be a digital asset data 55, and includes the corresponding public key 551 and private key 555.

In step S709, the purchased digital asset data 55 will not be stored in the exchange account 31, but will be directly transferred to the regulatory account 51 of the digital asset regulatory unit 50.

In other embodiments, the digital asset exchange 30 may be directly connected to the digital asset regulatory unit 50, or connected to the digital asset regulatory unit 50 through the financial unit 40, so that the digital asset data 55 of the exchange account 31 can be immediately uploaded to the regulatory account 51 for storage. In addition, the remaining transaction amount 33 will be immediately transferred to the financial account 41 of the financial unit 40 or the regulatory account 51 of the digital asset regulatory unit 50.

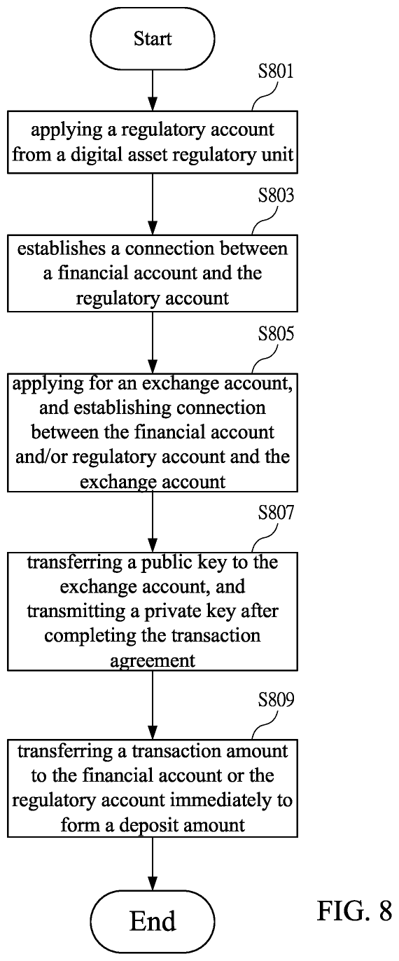

Please refer to FIG. 8, which is a flow chart of the digital asset management method according to another embodiment of the invention. Step S801 is the same as the step S701, step S803 is the same as step S703, and step S805 is the same as step S705. The invention further includes the following steps:

In step S807, when the user 21 wants to sell digital assets, such as the digital asset data 55, the user 21 can notify the digital asset regulatory unit 50 through the financial unit 40 to transfer the public key 551 and digital asset value 35 to the exchange account 31 of the digital asset exchange 30, or directly notify the digital asset regulatory unit 50 to transfer the public key 551 and digital asset value 35 to the exchange account 31 of the digital asset exchange 30, for example, through APP of the digital asset regulatory unit 50. When the digital asset exchange 30 completes the transaction agreement through the blockchain 29 or its internal transfer, the user 21 then sends the corresponding private key 555 to the digital asset exchange 30 to complete the sale of the digital asset data 55.

In step S809, the transaction amount 33 obtained by the digital asset exchange 30 after completing the sale of the digital asset data 55 will not be stored in the exchange account 31. The transaction amount 33 will be immediately transferred to the financial account 41 of the financial unit 40 or the regulatory account 51 of the digital asset regulatory unit 50, and become a deposit amount 415.

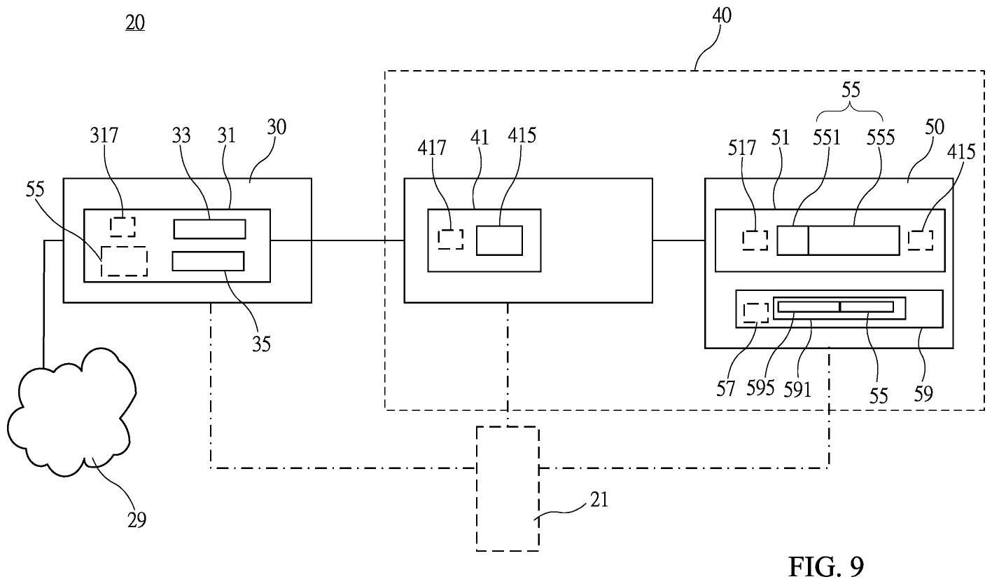

In addition, please refer to FIG. 9, which is an illustrative diagram of the digital asset management system according to another embodiment of the invention. The digital asset regulatory unit 50 of the invention includes a transaction ledger 59, which is used to store the transaction data 591 of the regulatory account 51 each time. The transaction data 591 includes but is not limited to a basic transaction data 595 and digital asset data 55. The basic transaction data 595 includes a transaction date, a transaction amount (33), name of a financial unit (40), a financial account (41), name of a digital asset exchange (30), and/or an exchange account (31). The digital asset data 55 includes a public key 551 and a private key 555.

In the invention, the digital asset regulatory unit 50 stores the public key 551 and private key 555 of the regulatory account 51. Therefore, when the user 21 forgets the private key 555, he can ask the digital asset regulatory unit 50 for the private key 555 corresponding to the public key 551. This can avoid the user 21 from being unable to trade the digital asset data 55 due to the loss of the private key 555.

In one embodiment of the invention, the transaction data 591 of the transaction ledger 59 in the digital asset regulatory unit 50 can be used to calculate and record the digital asset value 57 after each transaction, such as the number of cryptocurrency coins. The digital asset value 57 can be obtained by the digital asset regulatory unit 50 by querying the blockchain 29 according to the public key 551 of the digital asset data 55, and the digital asset value 57 can be stored in the transaction ledger 59.

The digital asset regulatory unit 50 of the invention may be an independent third-party institution or government agency that is independent of the financial unit 40. In another embodiment of the invention, the digital asset regulatory unit 50 may be a department of the financial unit 40, in other words, the digital asset regulatory unit 50 is set up in the financial unit 40.

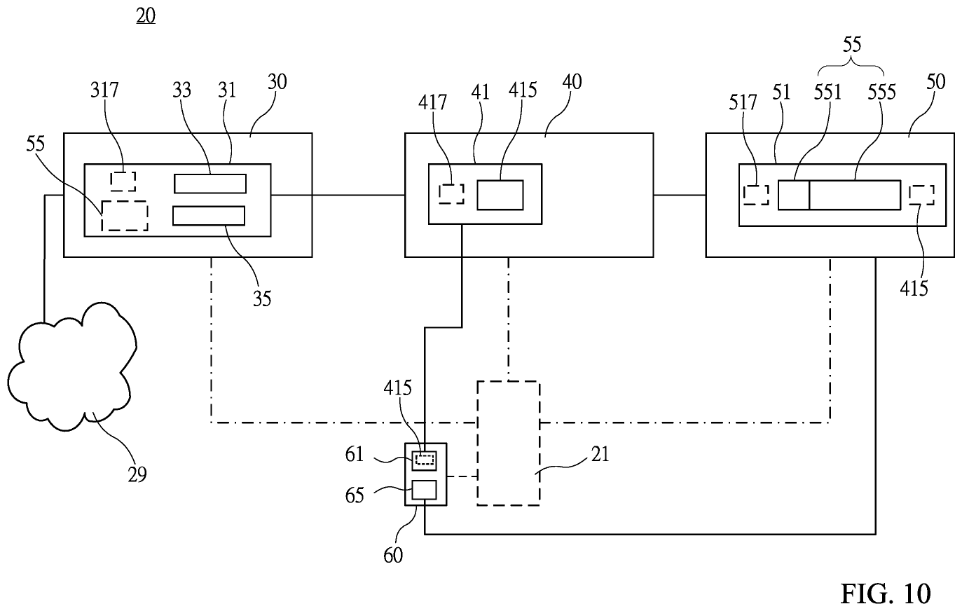

Please refer to FIG. 10, which is an illustrative diagram of the digital asset management system according to another embodiment of the invention. When the user 21 applies for the regulatory account 51 from the digital asset regulatory unit 50 through the financial unit 40, the financial unit 40 may generate a digital asset dual-reading card 60, which the user 21 can use. The digital asset dual-reading card 60 includes a first reading unit 61 and a second reading unit 65, wherein the first reading unit 61 is connected to the financial account 41 of the financial unit 40, and the second reading unit 65 is connected to the regulatory account 51 of the digital asset regulatory unit 50. The first reading unit 61 and the second reading unit 65 may include but are not limited to a magnetic stripe, a chip, a high-frequency electronic tag (HF electronic Tag), a near-field communication electronic tag (NFC electronic Tag), and/or a ultra high frequency electronic tag (UHF electronic Tag).

In one embodiment of the invention, the first reading unit 61 is a HF electronic tag, and the second reading unit 65 is a UHF electronic tag. The first reading unit 61 may be used to store the deposit amount 415. When the user 21 makes small purchases, he can hold the digital asset dual-reading card 60 close to the merchant's signal reader, and the merchant's signal reader can read the first reading unit 61, and the amount of the goods can be directly deducted from the deposit amount 415 of the first reading unit 61 or the financial account 41. For example, the first reading unit 61 may be a debit card or a credit card.

When the purchase amount exceeds the deposit amount 415 of the first reading unit 61 or the financial account 41, the user 21 can connect to the digital asset regulatory unit 50 by a computer or a communication device. The user 21 may use the application (APP) of the computer or communication device to read the second reading unit 65 of the digital asset dual-reading card 60 to verify the identity of the user 21. Then, the digital asset data 55 of the regulatory account 51 will be transferred to the exchange account 31 for selling the digital asset data 55. The transaction amount 33 obtained by selling the digital asset data 55 will be immediately deposited into the financial account 41 of the financial unit 40, to become the deposit amount 415. Thereafter, the user 21 can directly consume the deposit amount 415 in the financial account 41, or transfer the deposit amount 415 in the financial account 41 to the first reading unit 61 of the digital asset dual-reading card 60 and consume it.

The first reading unit 61 of the digital asset dual-reading card 60 may be a chip or a magnetic stripe, while the second reading unit 65 may be a high-frequency electronic tag or an access communication tag, which can be used for the purpose of paying for goods at a short distance and remote digital asset trading as described in the invention.

In addition, the user 21 can directly swipe the second reading unit 65 of the digital asset dual-reading card 60 to sell the digital asset value 57 and/or digital asset data 55. For example, when the second reading unit 65 of the digital asset dual-reading card 60 of the user 21 is read by a merchant's digital asset reader, the regulatory account 51 of the digital asset regulatory unit 50 can be activated. The user 21 can input the regulatory password 517 of the regulatory account 51, and input the digital asset value 57 and/or digital asset data 55 to be deducted, or authorize the merchant's digital asset reader to input and deduct the digital asset value 57 and/or digital asset data 55, wherein the deducted digital asset value 57 and/or digital asset data 55 can be converted or transferred to the merchant's digital asset reader.

If the digital asset data 55 in the regulatory account 51 is less than the digital asset value 57 to be converted or transferred, the deposit amount 415 of the first reading unit 61 or the financial account 41 can be immediately deposited into the exchange account 31 of the digital asset exchange 30 to purchase digital asset value 35, and the digital asset value 35 can be transferred to the regulatory account 51 or the merchant's digital asset reader.

The digital assets mentioned above in the invention may include but are not limited to cryptocurrencies, such as Bitcoin (BTC), Ethereum (ETH), and Litecoin (LTC), as well as digital currencies, such as central bank digital currencies (CBDCs) and stablecoins, or non-fungible tokens (NFTs), such as digital artworks or digital entertainment.

The above disclosure is only the preferred embodiment of the present disclosure, and not used for limiting the scope of the present disclosure. All equivalent variations and modifications on the basis of shapes, structures, features and spirits described in claims of the present disclosure should be included in the claims of the present disclosure.

What is claimed is:

1. A digital asset management system, comprising:
a financial unit comprising a financial account, wherein the financial account is connected to a cryptocurrency wallet or located in an exchange account of a digital asset exchange; and
a digital asset regulatory unit connected to the financial unit, and comprising a regulatory account that corresponds to the financial account, wherein the regulatory account stores at least one digital asset data that comprises a public key and a private key.

2. The digital asset management system according to claim 1, wherein the financial account or the regulatory account stores a deposit amount.

3. The digital asset management system according to claim 1, wherein the digital asset regulatory unit comprises a transaction ledger, which is used to store at least one transaction data corresponding to the digital asset data.

4. The digital asset management system according to claim 3, wherein the transaction data includes a basic transaction data and the digital asset data.

5. The digital asset management system according to claim 1, further comprising a digital asset dual-reading card, which comprises a first reading unit and a second reading unit, wherein the first reading unit is connected to the financial account, and the second reading unit is connected to the regulatory account.

6. The digital asset management system according to claim 1, wherein the digital asset regulatory unit is established in the financial unit.

7. The digital asset management system according to claim 1, wherein the digital asset regulatory unit is independent of the financial unit.

8. The digital asset management system according to claim 5, wherein the first reading unit is readable for a signal reader, and the second reading unit is readable for a digital asset reader.

9. A digital asset management method, comprising:
applying for a regulatory account by a user from a digital asset regulatory unit, or applying for the regulatory account by the user from the digital asset regulatory unit through a financial unit, wherein the regulatory account is located within the digital asset regulatory unit;
establishing a connection between the regulatory account and a financial account;
establishing a connection between the financial account and an exchange account or a cryptocurrency wallet; and
storing at least one digital asset data in the regulatory account, wherein the digital asset data is transmitted from the exchange account or the cryptocurrency wallet, wherein the digital asset data includes a public key and a private key.

10. The digital asset management method according to claim 9, wherein the user applies for the exchange account directly from a digital asset exchange or through the financial unit to establish the exchange account.

11. The digital asset management method according to claim 9, further comprising:
generating the digital asset data or a transaction amount in the exchange account;
transmitting and storing the digital asset data in the regulatory account immediately; and
transmitting and stored the transaction amount in the financial account or the regulatory account to form a deposit amount.

12. The digital asset management method according to claim 9, further comprising:
recording at least one transaction data related to the digital asset data in a transaction ledger, wherein the transaction ledger is established in the digital asset regulatory unit.

13. The digital asset management method according to claim 9, further comprising:
applying to the financial unit or the digital asset regulatory unit by the user to generate a digital asset dual-reading card, wherein the digital asset reading card includes a first reading unit and a second reading unit, the first reading unit is connected to the financial account of the financial unit, and the second reading unit is connected to the regulatory account of the digital asset regulatory unit.

14. The digital asset management method according to claim 13, further comprising:
reading the first reading unit for purchasing a product to use a deposit amount stored in the financial unit or the first reading unit; and
reading the second reading unit for trade the digital asset data to activate the regulatory account to connect to a digital asset exchange or the cryptocurrency wallet.

15. The digital asset management method according to claim 14, further comprising:
reading the second reading unit to transmit the digital asset data in the regulatory account to the digital asset exchange for sale, when the deposit amount in the financial unit is insufficient; and
transferring a transaction amount obtained by selling the digital asset data to the financial unit immediately.

16. The digital asset management method according to claim 9, wherein the digital asset data is transmitted to or transmitted from the regulatory account through the financial unit.

17. The digital asset management method according to claim 12, further comprising:
querying at least one blockchain by the digital asset regulatory unit to obtain a digital asset value of the digital asset data, and storing the digital asset value in the transaction ledger.
